(19) United States
(12) Patent Application Publication
(10) Pub. No.: US 2016/0222995 A1
(43) Pub. Date: Aug. 4, 2016

(54) PISTON LIMIT SENSING FOR FLUID APPLICATION

(71) Applicant: Wagner Spray Tech Corporation, Plymouth, MN (US)

(72) Inventor: Daniel R. Zientara, Lakeville, MN (US)

(73) Assignee: Wagner Spray Tech Corporation

(21) Appl. No.: 15/005,169

(22) Filed: Jan. 25, 2016

Related U.S. Application Data
(60) Provisional application No. 62/109,796, filed on Jan. 30, 2015.

(51) Int. Cl. F15B 15/28; F16H 25/20; B05B 12/08; F16H 25/22

(52) U.S. Cl. CPC F15B 15/2861; F15B 15/28; F15B 15/2807; F15B 15/2815; F16H 25/2252; F16H 25/2015; B05B 12/08

(57) ABSTRACT

Embodiments of the present disclosure describe a liquid delivery system that includes a cylinder, a piston within the cylinder, a rod connected to the piston, and a limit sensor system having a magnet connected to the rod, outside the cylinder. The magnet can have a first position corresponding to the piston located at a first stroke limit position and a second position corresponding to the piston located at a second stroke limit position. Furthermore, the limit sensor system can have reed switches located outside the cylinder and configured to actuate when the magnet is at the first position and the second position.

### CROSS-REFERENCE TO RELATED APPLICATION

This application claims the benefit of U.S. Provisional Application No. 62/109,796, filed Jan. 30, 2015, the content of which is incorporated herein in its entirety.

### BACKGROUND

The present disclosure relates to liquid pumps, and more specifically, to a limit sensor system used to determine the position of a piston in a liquid delivery system. Position sensing can provide instantaneous analog or digital electronic position feedback information about the piston within a cylinder.

### SUMMARY

A liquid delivery system is disclosed. The liquid delivery system includes a cylinder having an end, a piston within the cylinder, and a rod connected to the piston and extending at least to the end of the cylinder. The liquid delivery system can also include a limit sensor system having a magnet connected to the rod, outside the cylinder and on an opposite side of the end of the cylinder as the piston. The magnet can have a first position corresponding to the piston located at a first stroke limit position and a second position corresponding to the piston located at a second stroke limit position. Furthermore, the limit sensor system can have sensors such as reed switches located outside the cylinder and configured to sense when the magnet is at the first position and when the magnet is at the second position.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts an exemplary painting system, consistent with embodiments of the present disclosure.

FIGS. 2A and 2B depict an exemplary pump assembly, consistent with embodiments of the present disclosure.

FIG. 3 depicts an exemplary exploded view of a pump assembly, consistent with embodiments of the present disclosure.

FIG. 4A depicts an exemplary cylinder in a first position with a limit sensor system, consistent with embodiments of the present disclosure.

FIG. 4B depicts the exemplary cylinder in a second position with a limit sensor system, consistent with embodiments of the present disclosure.

FIG. 5A depicts an exploded view of an exemplary planetary roller screw drive, consistent with embodiments of the present disclosure.

FIG. 5B depicts an assembled view of the exemplary planetary roller screw drive, consistent with embodiments of the present disclosure.

FIG. 6A depicts an exemplary planetary roller screw drive in a first position with a limit sensor system, consistent with embodiments of the present disclosure.

FIG. 6B depicts the exemplary planetary roller screw drive in a second position with a limit sensor system, consistent with embodiments of the present disclosure.

FIG. 7 depicts an exemplary hydraulic circuit, consistent with embodiments of the present disclosure.

While embodiments of the present invention are amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to hydraulic powered liquid pumps, more particular aspects relate to a limit sensor system used to determine the position of a piston in a liquid delivery system. While the present disclosure is not necessarily limited to such applications, various aspects of the disclosure may be appreciated through a discussion of various examples using paint as context.

According to various embodiments, the liquid delivery system can include a hydraulic cylinder. The hydraulic cylinder can be a mechanical actuator that distributes a force on a liquid using reciprocating piston strokes. The piston is connected to a piston rod or other suitable structure and movement of the piston causes the reciprocal movement of the piston rod. The cylinder is closed on one end by a cylinder top (hereinafter referred to as the head) and on the other end by a cylinder bottom (hereinafter referred to as the base) where the piston rod comes out of the cylinder. In a hydraulic powered liquid delivery system, the hydraulic cylinder derives its power from a pressurized hydraulic fluid. In certain embodiments, an actuator (e.g., a solenoid valve) can direct the hydraulic fluid flow generated by a hydraulic pump through a first port (e.g., a port near the head hereinafter referred to as the head port) located on the cylinder. As the hydraulic fluid is directed by the actuator to the head port, pressure builds in the cylinder to force the piston to move from the head, through the cylinder, and to the base.

In various embodiments, a limit sensor system can be used to detect that the piston has reached the end of its stroke. The limit sensor system can include a magnet and reed switches. During each piston stroke, a portion of the piston rod remains outside the cylinder, regardless of the location of the piston inside the cylinder. In particular embodiments, the magnet is located on this portion of the piston rod (on the opposite side of the base of the cylinder as the piston), enabling the magnet to remain outside the cylinder as well. When the piston has completed a stroke, the magnetic field created by the magnet causes the reed switch to open or close. The reed switch can be connected to an electrical circuit that can feed logic gates that enable the actuator to direct the hydraulic fluid through the valve into a second port (e.g., a port near the base hereinafter referred to as the rod port) located on the cylinder. As the hydraulic fluid is directed by the actuator to the rod port, pressure builds in the cylinder to force the piston to move from the base, through the cylinder, and to the head. During this process, the hydraulic fluid is forced into the head port, back into the actuator, and returned to a hydraulic fluid reservoir. As the piston moves from the base to the head, the magnetic field applied to the reed switch decreases and the reed switch will change its state (open if application of the magnetic field forced it to close and close if application of the magnetic field forced it to open). As the piston draws near the head and approaches the second reed switch, its magnetic field causes the second reed switch to change its state.

In various embodiments, since the magnet is located on the portion of the piston rod that is outside of the cylinder, the magnet is not exposed to the pressurized hydraulic fluid inside the cylinder. This may protect the magnet from damage and corrosion that could occur from exposure to the hydraulic fluid if the magnet was located in the cylinder (e.g., on the piston). Moreover, if the magnet becomes damaged (e.g., cracked or has depleted magnetic properties), it may need to be repaired or replaced. However, because the magnet is located outside the cylinder, the hydraulic pump does not need to be disassembled to repair or replace the magnet.

According to particular embodiments, the reed switches may also be located outside the cylinder. As a result, in a paint delivery system, the reed switches, reed switch connectors, and an electrical circuit board may be exposed to paint. In particular embodiments, the reed switches and the reed switch connectors can be hermetically sealed and the electrical circuit board can be enclosed to protect them from damage, corrosion, and depletion of sensor properties that may be caused from exposure to the paint.

Embodiments of the present disclosure will now be described more fully hereinafter with reference to the accompanying figures. However, there can be several embodiments of the present invention and the present invention is not limited to the embodiments set forth herein. The embodiments disclosed are provided so that this disclosure can fully convey the scope of the invention to those skilled in the art. Therefore, the following detailed description is not to be taken in a limiting sense.

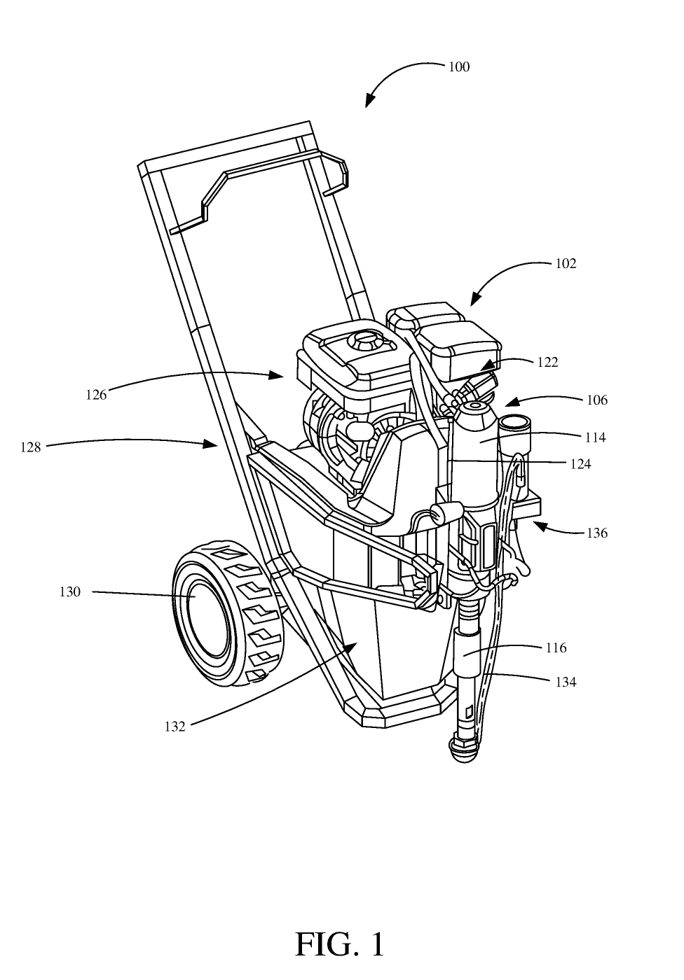

FIG. 1 depicts an exemplary painting system 100 that includes an upper shroud 126, a frame 128, wheels 130, a lower shroud 132, a motor system 102, a solenoid valve (not shown in FIG. 1) under the lower shroud 132, a pump assembly 106, a hydraulic motor 136, and a paint reservoir (not shown). The motor system 102 can be electrically powered, gas powered, etc. and can include a hydraulic pump (not shown in FIG. 1) under the lower shroud 132 and a hydraulic fluid reservoir (not shown in FIG. 1) also under the lower shroud 132. The hydraulic pump delivers hydraulic fluid (e.g., oil) from the hydraulic fluid reservoir to the solenoid valve. The solenoid valve can be an electromechanical device that includes a solenoid, a head port on the valve body and a rod port on the valve body. The head port on the valve body and the rod port on the valve body can be controlled by an electric current through the solenoid. For the solenoid valve, the electric current can alternate the flow from the head port on the valve body and the rod port on the valve body.

According to various embodiments, the pump assembly 106 includes a hydraulic cylinder 114 and a paint pump 116. The solenoid valve directs the hydraulic fluid, generated by the hydraulic pump, through the head port on the valve body to a head port 122 of the hydraulic cylinder 114. As the hydraulic fluid is directed by the solenoid valve through the head port 122 of the hydraulic cylinder 114, pressure builds in the cylinder and forces the hydraulic piston to move. As the hydraulic piston moves through the cylinder, the hydraulic fluid is forced through a rod port 124 of the hydraulic cylinder 114, into the solenoid valve through the rod port on the valve body, and returned to the hydraulic fluid reservoir. In addition, a hydraulic piston rod (not shown in FIG. 1), connected to the hydraulic piston, can also be connected to a paint piston rod (not shown in FIG. 1). As a result, the hydraulic piston moves the paint piston rod through the paint pump 116 to pump paint from the paint reservoir to an outlet hose 134 connected to a paint applicator (not shown in FIG. 1).

In particular embodiments, a magnet is connected to the hydraulic piston rod. Moreover, at least two sensors are located outside the cylinder that correspond to the two limit positions of the hydraulic piston at each end of its stroke, hereinafter referred to as a stroke limit position. In certain embodiments, the sensor can be a reed switch. A reed switch is an electrical switch operated by an applied magnetic field. It may consist of a pair of contacts on 1 reeds in a hermetically sealed airtight envelope constructed from a suitable material, such as glass or plastic. In certain embodiments, the contacts can be open, making no electrical contact. The switch can be closed by bringing the magnet near the switch. Once the magnet is pulled away, the reed switch will open again. In other embodiments, the contacts can be closed and the switch can be opened by bringing the magnet near the switch. Once the magnetic field is removed, the reed switch closes.

For example, as the hydraulic piston moves from the head, through the cylinder, a magnet located on the hydraulic piston rod moves closer to a first reed switch. When the hydraulic piston has reached a stroke limit position in the cylinder, the magnetic field closes the first reed switch and completes an electrical circuit (not shown in FIG. 1). The electrical circuit can provide a voltage or other suitable indication that activates a set of metal oxide semiconductor field effect transistors (MOSFETs) or other suitable switching devices to change the state of the solenoid. In this example, the hydraulic fluid can now be released from the rod port on the valve body, into the cylinder through the rod port 124 of the hydraulic cylinder 114. As the hydraulic piston moves through the cylinder in the opposite direction, the magnetic field strength, with respect to the first reed switch, decreases and the first reed switch opens. Moreover, the hydraulic fluid can be pushed back through the head port 122 of the hydraulic cylinder 114, into the solenoid valve through the head port on the valve body, and returned to the hydraulic fluid reservoir. The paint piston rod can then move through the paint pump 116 and continue to pump paint from the paint reservoir. When the hydraulic piston has reached a stroke limit position, the magnetic field causes a second reed switch to close, thereby completing the electrical circuit, and reverse the hydraulic fluid flow from the solenoid valve.

In another embodiment, a hall-effect sensor system can be used to determine when the hydraulic piston has reached the end of a piston stroke. A hall-effect sensor system can include a magnet and a sensor. In various embodiments, the hall-effect sensor system can be hermetically sealed or enclosed. The sensor can be a transducer that varies its output voltage in response to an applied magnetic field produced by the magnet. When the hydraulic piston has reached a stroke limit position, the magnet is located at a position such that its magnetic field is perpendicular with respect to the sensor. The perpendicular magnetic field can induce the output voltage from the sensor that enables the solenoid valve to alternate the flow of the hydraulic fluid.

In another embodiment, a photoelectric sensor is used to determine that the hydraulic piston has reached a stroke limit position. A photoelectric sensor is a device used to detect the distance, absence, or presence of an object by using a light transmitter and a photoelectric receiver. In yet further embodiments, other sensors can be used that include, but are not limited to, mechanical sensors, base active transducer sensors, eddy-current sensors, inductive position sensors, photodiode array sensors, and proximity sensors. In particular embodiments, the sensor systems can be hermetically sealed or enclosed to protect them from exposure to the paint.

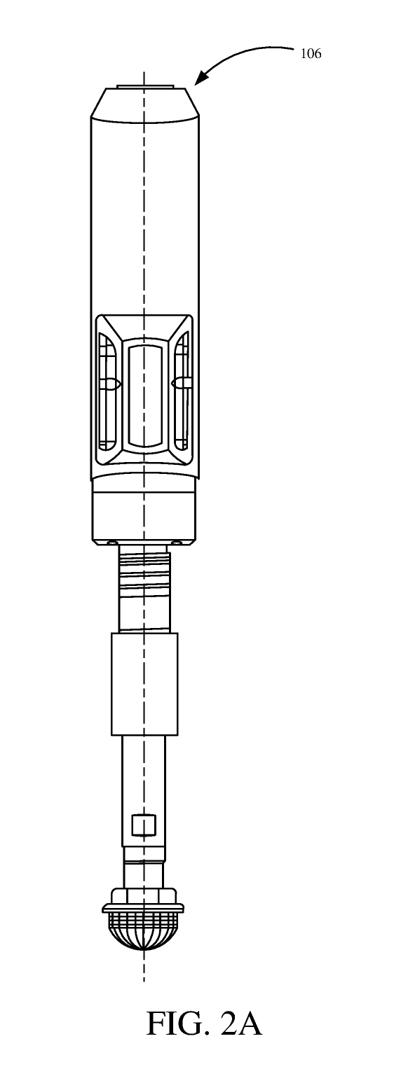

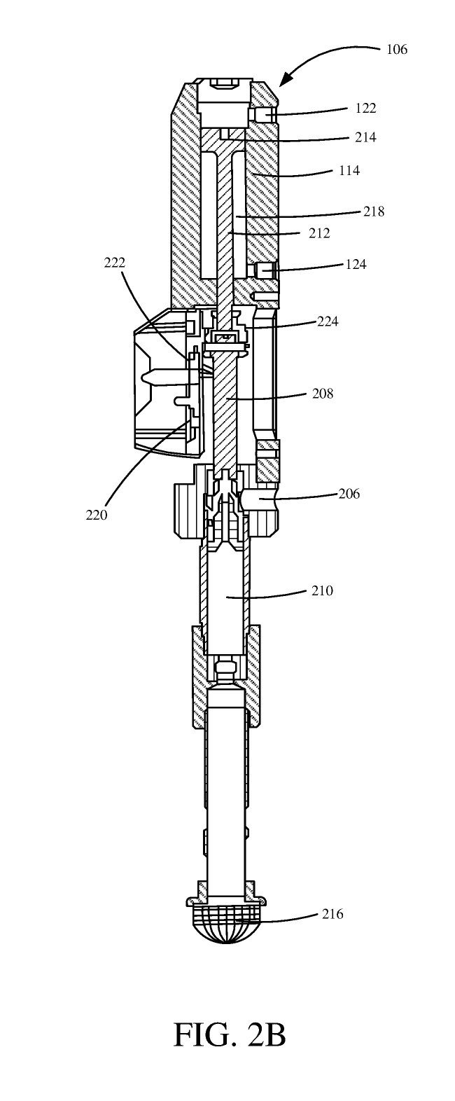

FIG. 2A depicts an outside view of the exemplary pump assembly 106 and FIG. 2B depicts an inside view of the exemplary pump assembly 106. As can be seen in FIG. 2B, the pump assembly 106 includes head port 122 of the hydraulic cylinder 114, rod port 124 of the hydraulic cylinder 114, a hose outlet 206, a paint piston rod 208, a paint pump cavity 210, a hydraulic piston rod 212, a hydraulic piston 214, a paint intake 216, a hydraulic cylinder cavity 218, a first reed switch 220, a second reed switch 222, and a magnet 224. An actuator (e.g., solenoid valve) directs a hydraulic fluid into the hydraulic cylinder cavity 218 through head port 122 of hydraulic cylinder 114. The hydraulic fluid forces hydraulic piston 214 to move down through the hydraulic cylinder cavity 218. As the hydraulic piston 214 moves down through the hydraulic cylinder cavity 218, the paint piston rod 208 moves down through the paint pump cavity 210 and pushes the paint out hose outlet 206. In addition, hydraulic fluid is forced back through the rod port 124 of the hydraulic cylinder 114, into the solenoid valve and returned to a hydraulic fluid reservoir.

When hydraulic piston 214 is at a stroke limit position, magnet 224 causes first reed switch 220 to close and complete an electrical circuit (not shown in FIG. 2B). The electrical circuit provides a voltage or other suitable indication that reverses the state of the solenoid valve and causes the hydraulic fluid to flow into the hydraulic cylinder cavity 218 through the rod port 124 of the hydraulic cylinder 114, thereby reversing the direction of piston 214. As piston 214 travels up, the hydraulic fluid is forced back through the head port 122 of the hydraulic cylinder 114, into the solenoid valve and returned to the hydraulic fluid reservoir. The paint piston rod 208 also moves up through the paint pump cavity 210 and draws the paint through the paint intake 216. When the hydraulic piston has reached its upper stroke limit position, the magnet 224 causes second reed switch 222 to close, thereby completing an electrical circuit and reversing the hydraulic fluid flow into the hydraulic cylinder cavity through the head port 122 of the hydraulic cylinder 114.

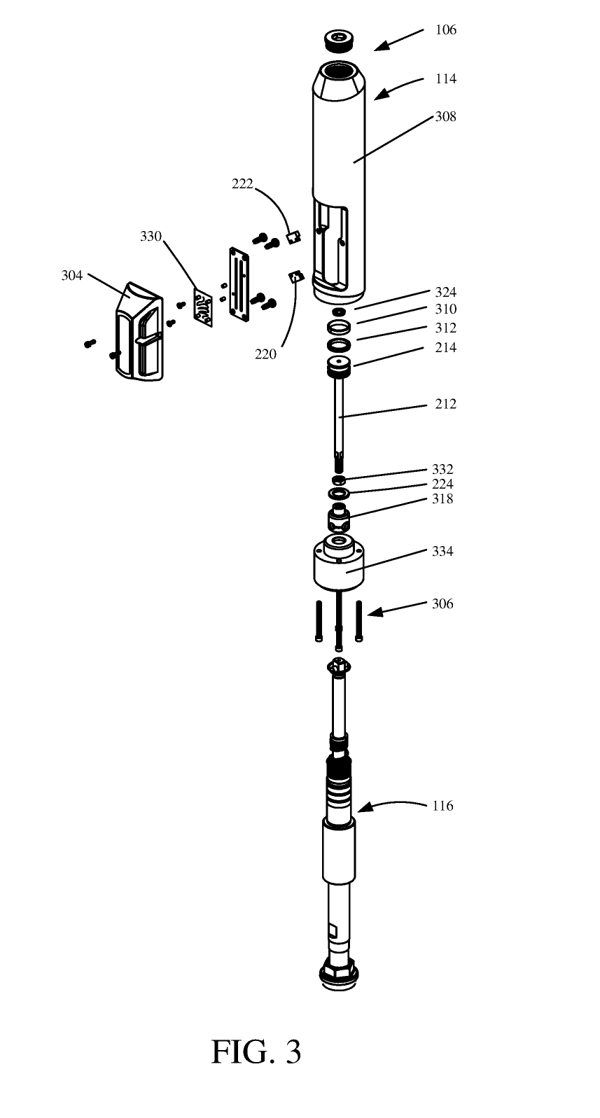

FIG. 3 depicts an exploded view of the exemplary pump assembly 106, consistent with embodiments of the present disclosure. The pump assembly 106 includes hydraulic cylinder 114, paint pump 116, and sensor cover assembly 304. The sensor cover assembly 304 can prevent paint from entering the area where the paint piston rod (e.g., paint piston rod 208, from FIG. 2) and the hydraulic piston rod 212 are coupled together and can prevent paint from reaching magnet 224 and reed switches 220 and 222. In addition, sensor cover assembly 304 can include first reed switch 220, the second reed switch 222, and a circuit board 330.

As shown in FIG. 3, hydraulic cylinder 114 can include hydraulic cylinder fasteners 306, cylinder 308, piston head wear ring 310, piston head seal 312, hydraulic piston 214, hydraulic piston rod 212, magnet 224, hydraulic piston coupler 318, piston rod seal 324, jam nut 332, and a fluid section block 334. Hydraulic cylinder fasteners 306 securely attaches the cylinder 308 to the fluid section block 334. The cylinder 308 can include the hydraulic cylinder cavity 218, from FIG. 2, the head port 122 of the hydraulic cylinder 114, from FIG. 2, and the rod port 124 of the hydraulic cylinder 114, from FIG. 2. The piston head wear ring 310 is a ring that fits into a groove on the outer diameter of hydraulic piston 214. The piston head seal 312 can be a dynamic seal. It can be single acting or double acting and it can be made from nitrile rubber, polyurethane, fluorocarbon viton, etc. The jam nut 332 can lock the hydraulic piston coupler onto the piston rod 212 and the hydraulic piston coupler 318 can attach the hydraulic piston rod 212 to a paint piston rod (e.g., paint piston rod 208, from FIG. 2).

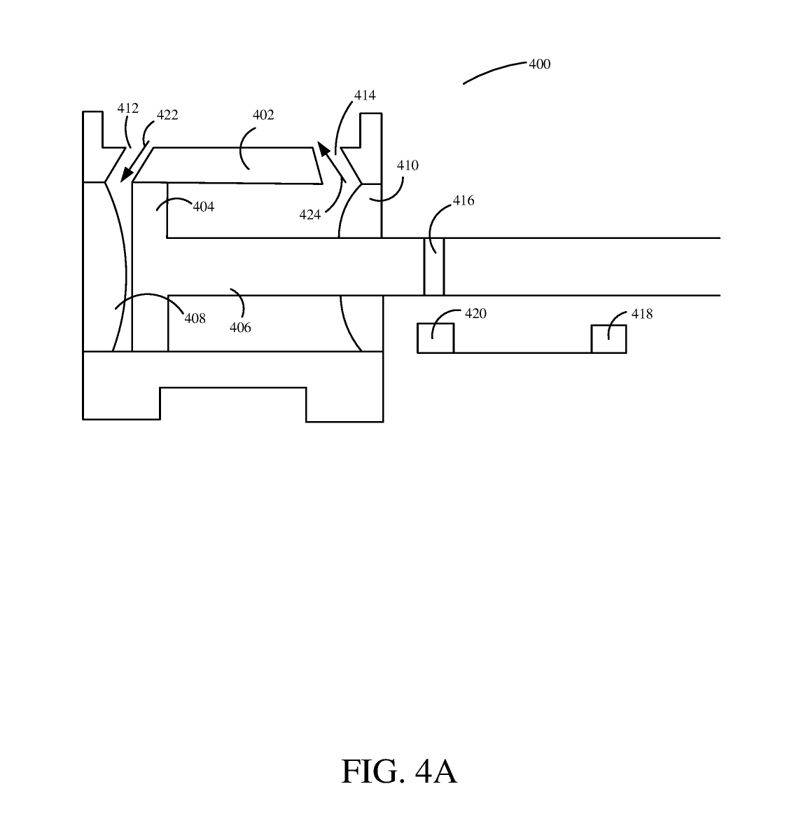

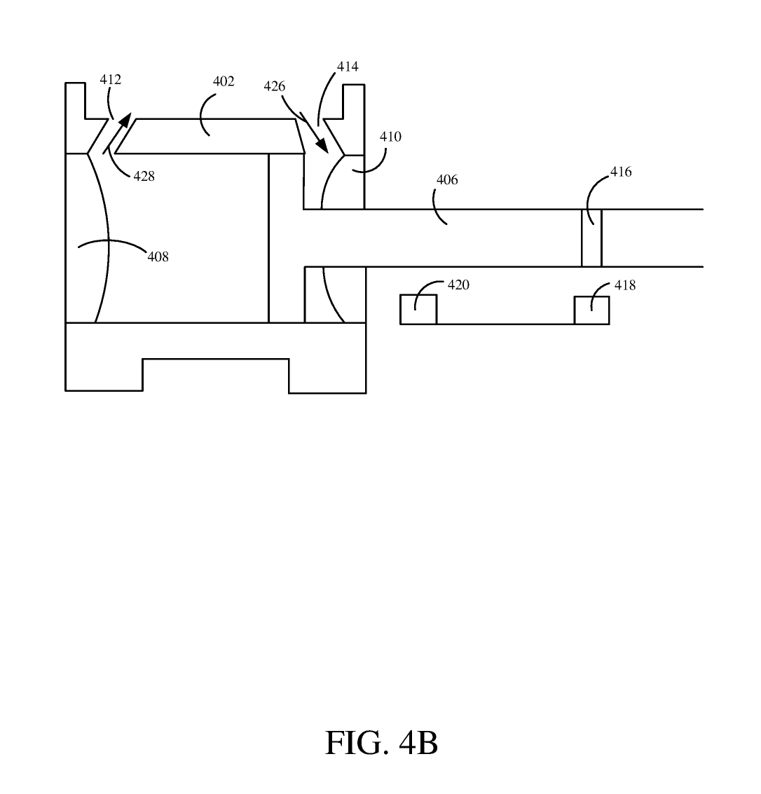

FIG. 4A depicts an exemplary hydraulic cylinder 402 in a first position with a limit sensor system, consistent with embodiments of the present disclosure. The hydraulic cylinder 402 can include piston 404, piston rod 406, head 408, base 410, head partition 412, base partition 414, magnet 416, first reed switch 420, and second reed switch 418.

According to various embodiments, as shown in FIG. 4A, the piston 404 is initially located at a stroke limit position, near head 408 and magnet 416 causes first reed switch 420 to change state and complete an electrical circuit (not shown in FIG. 4A). The electrical circuit provides a voltage or other suitable signal to reverse the state of an actuator (e.g., a solenoid valve) and direct hydraulic fluid into the cylinder 402 through the head partition 412 (as shown by arrow 422). As the hydraulic fluid flows through the head partition 412, piston 404 is forced away from head 408. As the piston 404 moves through the cylinder 402, first reed switch 420 changes state and the hydraulic fluid is forced back into the actuator through the base partition 414 (as shown by arrow 424).

FIG. 4B depicts the exemplary hydraulic cylinder 400 in a second position with a limit sensor system, consistent with embodiments of the present disclosure. Magnet 416 is positioned on the piston rod 406 such that when the piston 404 moves through the cylinder 402 and approaches base 410, magnet 416 approaches second reed switch 418 and causes second reed switch 418 to change state. This will complete an electrical circuit and provide a voltage or other suitable signal to reverse the state of the solenoid valve and thus, reverse the flow of the hydraulic fluid and move the piston 404 away from base 410.

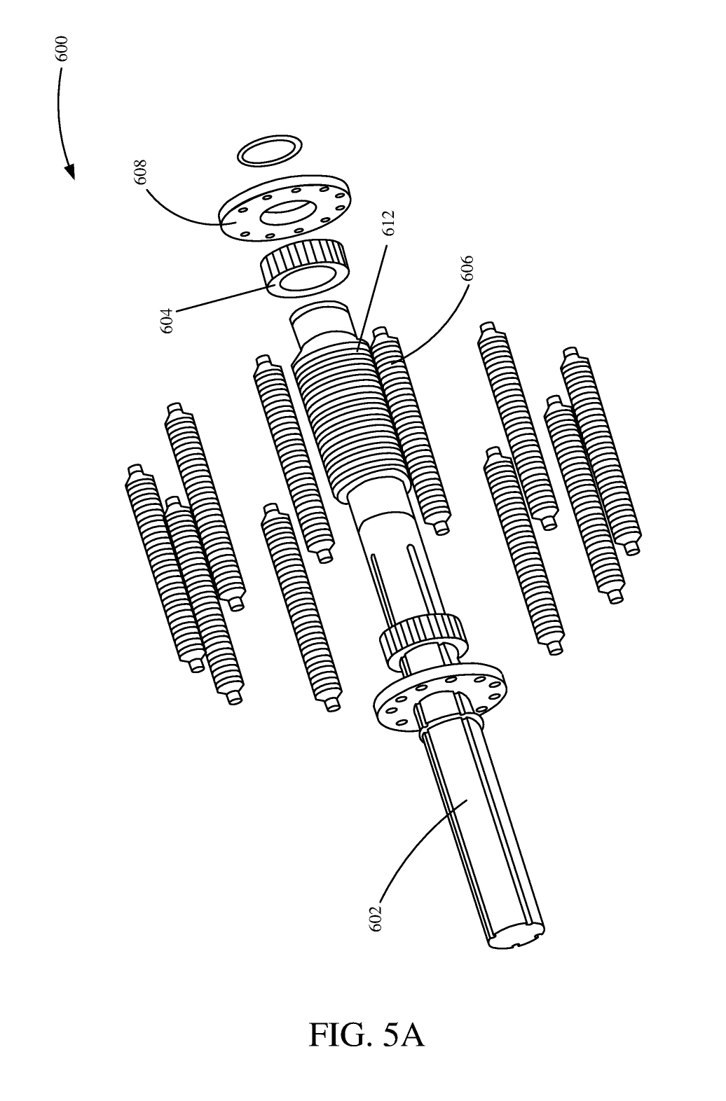

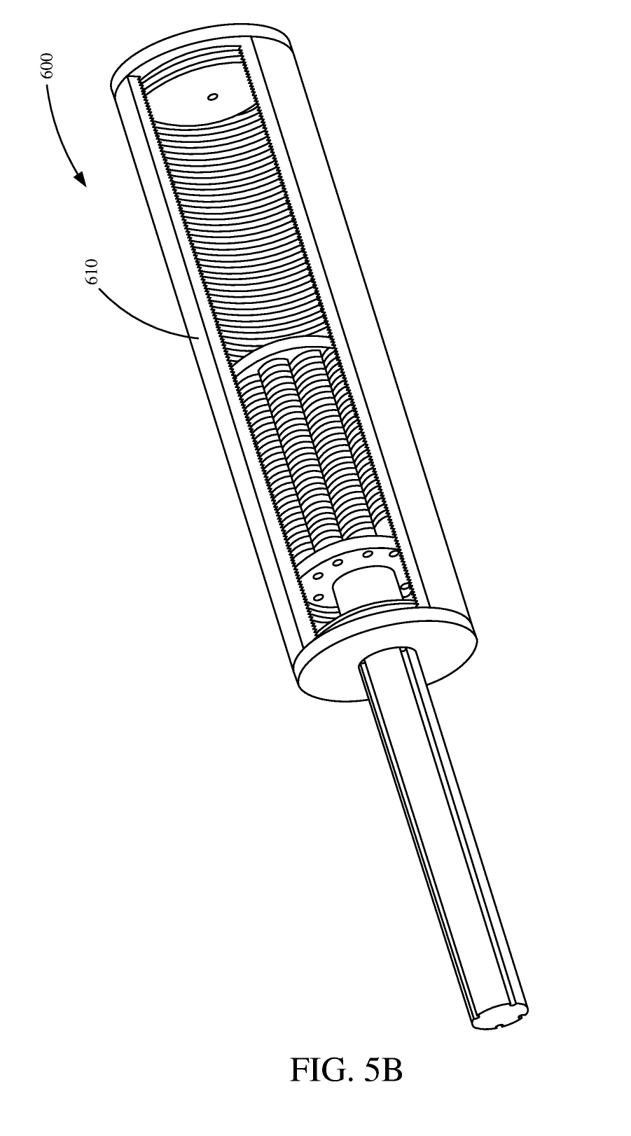

FIG. 5A depicts an exploded view of an exemplary planetary roller screw drive 600 and FIG. 5B depicts an assembled view of the exemplary planetary roller screw drive 600, consistent with embodiments of the present disclosure. The planetary roller screw drive 600 includes rod 602, cog 604, rollers 606, roller retainer 608, and tube 610. According to various embodiments, the planetary roller screw drive 600 can be used in place of or in combination with a hydraulic cylinder (e.g., hydraulic cylinder 400). The planetary roller screw drive 600 is a mechanical device for converting rotational motion to linear motion.

According to various embodiments, the threaded rod 602 provides a helical raceway or thread 612 for multiple rollers 606 radially arrayed around the rod 602 and encapsulated by the threaded tube 610. The lead for thread 612 is the axial travel for a single revolution. The pitch of thread 612 is defined as the axial distance between adjacent threads of the thread 612. The thread 612 of the rod 602 typically has the same pitch or corresponding features to the internal thread of the tube 610. The rollers 606 spin in contact with, and serve as transmission elements between the rod 602 and the tube 610. The rollers 606 typically have a single-start thread where a single helical thread is along their length and the lead and pitch are equal. This can limit the friction as the rollers 606 contact the rod 602 and the tube 610. The rollers 606 orbit the rod 602 as they spin and rotation of the tube 610 results in rod 602 travel, and rotation of the rod 602 results in tube 610 travel.

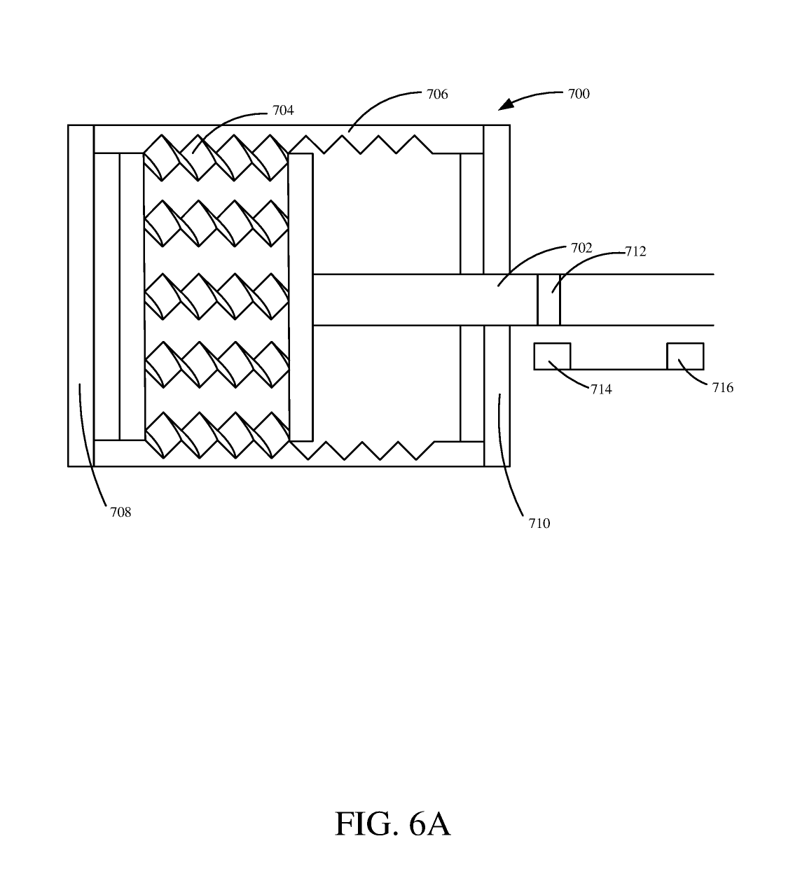

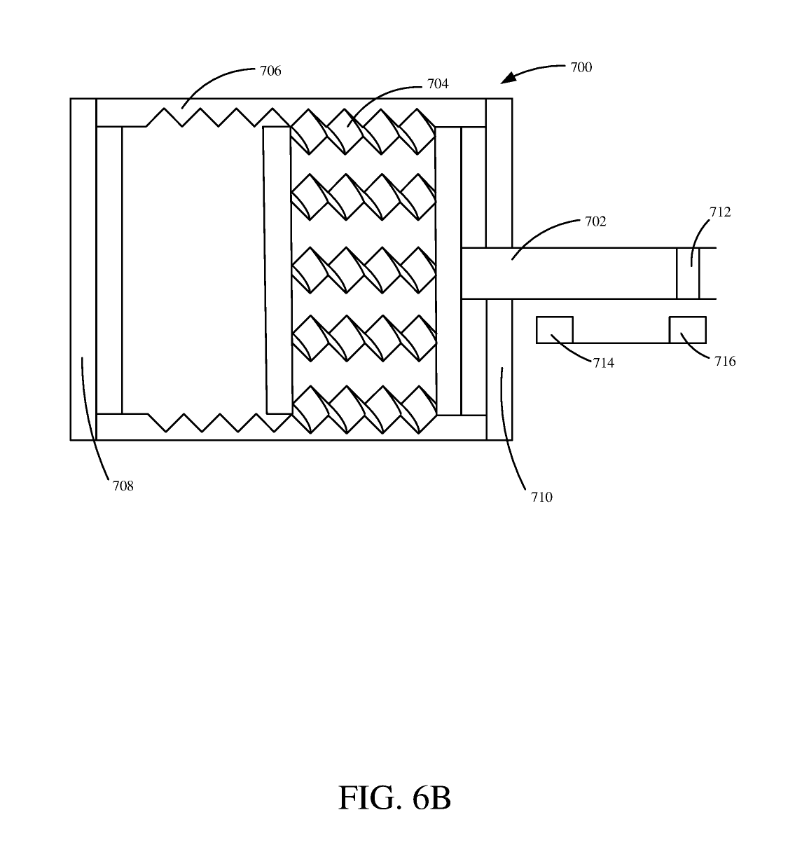

FIG. 6A depicts an exemplary planetary roller screw drive 700 in a first position with a limit sensor system, consistent with embodiments of the present disclosure. The planetary roller screw drive 700 can include a rod 702, rollers 704, tube 706, head 708, base 710, magnet 712, first reed switch 714, and second reed switch 716.

According to various embodiments, as shown in FIG. 6A, the rod 702 is initially located at a stroke limit position, near head 708 and magnet 712 causes first reed switch 714 to change state and complete an electrical circuit (not shown in FIG. 6A). The electrical circuit provides a voltage or other suitable signal to reverse the rotation of the rollers 704 and move the rod 702 away from head 708. As the rod 702 moves through the tube 706, first reed switch 714 changes state.

FIG. 6B depicts the exemplary planetary roller screw drive 700 in a second position with a limit sensor system, consistent with embodiments of the present disclosure. Magnet 712 is positioned on the rod 702 such that when the rod 702 moves through the tube 706 and approaches base 710, magnet 712 approaches second reed switch 716 and causes second reed switch 716 to change state. This will complete an electrical circuit and provide a voltage or other suitable signal to reverse the rotation of the rollers 704 and move the rod 702 away from base 710.

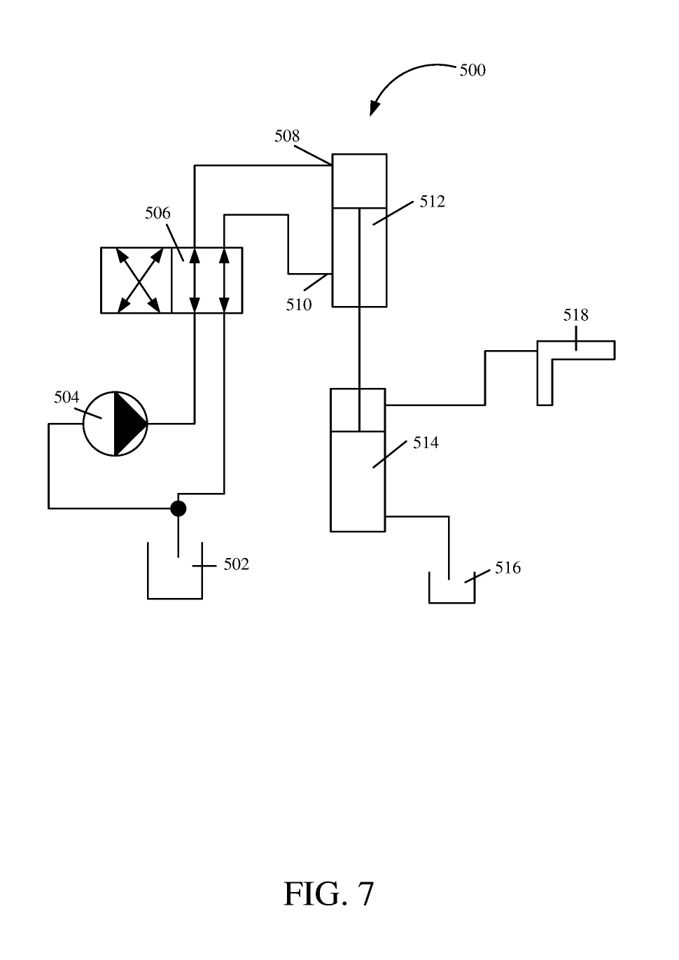

FIG. 7 depicts an exemplary hydraulic circuit 500, consistent with embodiments of the present disclosure. In various embodiments, the hydraulic circuit 500 can include a hydraulic reservoir 502, a hydraulic pump 504, a solenoid 506, a head port 508, a rod port 510, a hydraulic cylinder 512, a paint cylinder 514, a paint reservoir 516, and a spray gun 518. In certain embodiments, the hydraulic pump 504 can pump hydraulic fluid from the hydraulic reservoir 502 to the solenoid 506. In FIG. 7, the solenoid 506 is illustrated as a directional control valve. Directional control valves can allow fluid to flow into different paths from one or more sources. They can consist of a spool inside a cylinder and can be mechanically, electrically, and hydraulically controlled. Moreover, the movement of the spool can restrict or permit the flow of the hydraulic fluid from the hydraulic reservoir 502.

In this embodiment, an electromechanical solenoid is used to operate a 4-way, 2 position valve since there are 2 spool positions and 4 valve ports. However, other position valves can be used. The 4-way, 2 position valve combined with the reed switch sensor (not shown in FIG. 7) enables fast switching between the down stroke and the up stroke of the hydraulic cylinder 512. This allows the hydraulic circuit 500 to achieve a consistent paint pressure. In this example, initially, the head port 508 is the pressure port which is connected to the hydraulic pump 504 and the rod port is connected to the hydraulic reservoir 502. As the hydraulic fluid is directed into the head port 508 the pressure inside the hydraulic cylinder 512 forces the hydraulic piston to move down through the hydraulic cylinder 512 and the hydraulic fluid is pushed out the rod port 510 and back to the hydraulic reservoir 502. Since hydraulic piston is attached to the paint piston, the paint piston also moves down through the paint cylinder 514 and paint, located in the paint cylinder, is pushed into the spray gun 518.

When the hydraulic piston has reached a stroke limit position, the reed switch sensor can provide a voltage that activates a set of MOSFETs (not shown in FIG. 7) and the solenoid 506 slides the spool to its second position. As a result, rod port 510 is the pressure port which is connected to the hydraulic pump 504 and the head port is connected to the hydraulic reservoir 502. As the hydraulic fluid is directed into the rod port 510 the pressure inside the hydraulic cylinder 512 forces the hydraulic piston to move up through the hydraulic cylinder 512 and the hydraulic fluid is pushed out the head port and back to the hydraulic reservoir 502. Moreover, the paint piston also moves up through the paint cylinder 514 and paint from the paint reservoir 516 can be drawn up into the paint cylinder 516.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A liquid delivery system comprising:
a source of hydraulic fluid;
a hydraulic cylinder coupled to the source of hydraulic fluid having a piston movable between first and second limit positions;
a rod connected to the piston and extending out of the cylinder; and
at least one sensor located outside the cylinder configured to sense a position of the rod to provide a signal indication of the piston reaching the first position or the second position.

2. The liquid delivery system of claim 1, wherein the liquid delivery system is a reciprocating pump coupled to a paint pump.

3. The liquid delivery system of claim 1, further comprising a solenoid valve that sends the hydraulic fluid to the hydraulic cylinder and receives the hydraulic fluid from the cylinder.

4. The liquid delivery system of claim 1, wherein the liquid is paint.

5. The liquid delivery system of claim 1, wherein the at least one sensor includes a magnet connected to the rod and a set of reed switches configured to change state when the piston reaches the first position or the second position.

6. The liquid delivery system of claim 1, wherein the at least one sensor is a hall-effect sensor system.

7. The liquid delivery system of claim 1, wherein the at least one sensor is a photoelectric sensor.

8. The liquid delivery system of claim 1, wherein the at least one sensor is a proximity sensor.

9. A paint delivery system comprising:
a piston pump assembly including:
a source of hydraulic fluid;
a hydraulic cylinder coupled to the source of hydraulic fluid having a piston movable between first and second limit positions;
a rod connected to the piston and extending out of the cylinder; and
at least one sensor located outside the cylinder configured to sense a position of the rod to provide a signal indication of the piston reaching the first position or the second position;
a solenoid valve that sends fluid to the piston pump assembly and receives the fluid from the piston pump assembly;
a paint reservoir; and
a paint pump coupled to the piston to move the paint from the paint reservoir for application to a surface.

10. The paint delivery system of claim 9, wherein the piston pump assembly is a reciprocating pump.

11. The paint delivery system of claim 9, wherein the at least one sensor includes a magnet connected to the rod and a set of reed switches configured to change state when the piston reaches the first position or the second position.

12. The paint delivery system of claim 9, wherein the at least one sensor is a hall-effect sensor system.

13. The paint delivery system of claim 9, wherein the at least one sensor is a photoelectric sensor.

14. The paint delivery system of claim 9, wherein the at least one sensor is a proximity sensor.

15. A liquid delivery system comprising:
a planetary roller screw drive having a rod movable between first and second limit positions and a tube surrounding the rod; and
at least one sensor located outside the tube configured to sense a position of the rod to provide a signal indication of the rod reaching the first position or the second position.

16. The liquid delivery system of claim 15, wherein the planetary roller screw drive is coupled to a paint pump.

17. The liquid delivery system of claim 15, wherein the liquid is paint.

18. The liquid delivery system of claim 15, wherein the at least one sensor includes a magnet connected to the rod and a set of reed switches configured to change state when the rod reaches the first position or the second position.

19. The liquid delivery system of claim 15, wherein the planetary roller screw drive piston is a reciprocating drive.

20. The liquid delivery system of claim 15, wherein the at least one sensor is a hall-effect sensor system.
